(19) United States
(12) Patent Application Publication
(10) Pub. No.: US 2007/0126659 A1
(43) Pub. Date: Jun. 7, 2007

(54) Plasma display apparatus and driving method thereof

(75) Inventor: Byung Joon Rhee, Yongin-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/607,963

(22) Filed: Dec. 4, 2006

(30) Foreign Application Priority Data
Dec. 2, 2005 (KR) 10-2005-0116757

(51) Int. Cl. G09G 3/28

(52) U.S. Cl. 345/60

(57) ABSTRACT

There are provided a plasma display apparatus and a method of driving the same. A plasma display apparatus according to an embodiment of the present invention comprises a Plasma Display Panel (PDP) in which a plurality of scan electrode and sustain electrode pairs are formed, and a sustain pulse driver for supplying two or more sustain pulses having a different Energy Recovery (ER) time to at least one of the scan electrode and the sustain electrode for a specific period as a ratio of a specific sustain pulse number.

This Nonprovisional application claims priority under 35 U.S.C. §119(a) on Patent Application No. 10-2005-0116757 filed in Korea on Dec. 02, 2005, the entire contents of which are hereby incorporated by reference.

### BACKGROUND

1. Field

The present invention relates to a plasma display apparatus and a method of driving the same.

2. Discussion of Related Art

In general, a Plasma Display Panel (PDP) comprises a front substrate and a rear substrate. A barrier rib formed between the front substrate and the rear substrate forms one unit cell. Each cell is filled with an inert gas containing a primary discharge gas, such as neon (Ne), helium (He) or a mixed gas of Ne+He, and a small amount of xenon (Xe). If the inert gas is discharged with a high frequency voltage, it generates vacuum ultraviolet rays. The vacuum ultraviolet rays excite phosphors formed between the barrier ribs to implement images.

FIG. 1 is a perspective view illustrating the construction of a general PDP.

As shown in FIG. 1, the PDP comprises a front panel 100 and a rear panel 110, which are coalesced together with a specific gap therebetween. In the front panel 100, a plurality of sustain electrode pairs in which a scan electrode 102 and a sustain electrode 103 are formed in pairs are arranged on a front substrate 101 serving as a display surface on which images are displayed. In the rear panel 110, a plurality of address electrodes 113 crossing the plurality of sustain electrode pairs are arranged on a rear substrate 111 serving as a rear surface.

The front panel 100 has the pairs of scan electrodes 102 and sustain electrodes 103 for mutually discharging within one discharge cell and maintaining the emission of a cell. In other words, each of the scan electrode 102 and the sustain electrode 103 comprises a transparent electrode “a” formed from transparent ITO material and a bus electrode “b” formed from metal material. The scan electrodes 102 and the sustain electrodes 103 are covered with at least one dielectric layer 104 for limiting the discharge current and providing insulation between the electrode pairs. A protection layer 105 having Magnesium Oxide (MgO) deposited thereon is formed on the dielectric layer 104 in order to facilitate the discharge conditions.

In the rear panel 110, barrier ribs 112 of stripe form (or well form), for forming a plurality of discharge spaces, that is, discharge cells are arranged parallel to one another. Furthermore, one or more address electrodes 113 for causing the inert gas within the discharge cell to generate vacuum ultraviolet rays by performing an address discharge are disposed parallel to the barrier ribs 112. Red (R), green (G) and blue (B) phosphors 114 for radiating a visible ray in order to display images at the time of sustain discharge are coated on a top surface of the rear panel 110. A dielectric layer 115 for protecting the address electrodes 113 is formed between the address electrodes 113 and the phosphor layers 114.

The PDP constructed above comprises a plurality of discharge cells formed in matrix form, and a driver (not shown) comprising a driving circuit for supplying a pulse to the discharge cells.

FIG. 2 is a view illustrating a method of implementing images of a conventional plasma display apparatus.

As illustrated in FIG. 2, in the plasma display apparatus, in order to implement an image, one frame period is divided into several subfields having a different number of emissions, and a PDP is emitted in a subfield period corresponding to a gray level value of an input image signal.

Each subfield is divided into a reset period for making uniform discharge, an address period for selecting a discharge cell, and a sustain period for implementing gray levels depending on the number of discharges. For example, if it is sought to display an image with 256 gray levels, a frame period (16.67 ms) corresponding to 1/60 seconds is divided into eight sub-fields.

Each of the eight sub-fields is subdivided into a reset period, an address period and a sustain period. The sustain period increases in the ratio of 2ⁿ (where n=0,1,2,3,4,5,6,7) in each subfield. Since the sustain period is varied every sub-field as described above, gray levels of an image can be implemented.

Actual display light for implementing an image as described above is generated by a sustain pulse alternately applied to the scan electrode and the sustain electrode during the sustain period. In the prior art, in order to efficiently supply the sustain pulse, an energy recovery circuit is provided to raise or fall the sustain pulse through L-C resonance. An Energy Recovery (ER)-up time of the sustain pulse is varied depending on the operating timing of the energy recovery circuit. This serves as an important factor to influence the driving of the plasma display apparatus. In particular, there are problems in that as the ER-up time is shortened, driving efficiency is decreased, and as the ER-up time is lengthened, driving margin is reduced.

### SUMMARY

Accordingly, the present invention is to solve at least the problems and disadvantages of the background art, and provides a plasma display apparatus with an improved driving margin by improving a plasma display apparatus and a method of driving the same.

Furthermore, the present invention provides a plasma display apparatus with an improved driving efficiency by improving a plasma display apparatus and a method of driving the same.

Furthermore, the present invention provides a plasma display apparatus and a method of driving the same that can be driven efficiently and stably.

A plasma display apparatus according to an embodiment of the present invention may comprise a PDP in which a plurality of scan electrode and sustain electrode pairs are formed, and a sustain pulse driver for supplying two or more sustain pulses having a different ER time to at least one of the scan electrode and the sustain electrode for a specific period as a ratio of a specific sustain pulse number.

The specific period may comprise at least one subfield period.

The ratio of the specific sustain pulse number may be different every subfield period.

The ER time may be at least one of an ER-up time and an ER-down time.

The sustain pulse may comprise a first sustain pulse having a first ER-up time, and a second sustain pulse having a second ER-up time longer than the first ER-up time.

The first ER-up time and the second ER-up time may be divided based on 500 ns.

The plasma display apparatus may further comprise a sustain pulse controller for controlling the sustain pulse driver according to the ratio of the specific sustain pulse number.

The sustain pulse controller may previously set a specific threshold value corresponding to the smallest driving margin, and control the number of sustain pulses so that the ratio of the specific sustain pulse number is smaller than the threshold value.

The threshold value may be a ratio of the smallest number of sustain pulses having a short ER time and the greatest number of sustain pulses having a long ER time, of sustain pulses having a different ER time.

The sustain pulse driver may apply all the second sustain pulses in the first half of one subfield period, and apply the first sustain pulses posterior to the last second sustain pulse, according to the ratio of the specific sustain pulse number.

The sustain pulse driver first may apply the second sustain pulse to one of the scan electrode and the sustain electrode, and then apply the first sustain pulse to the other of the scan electrode and the sustain electrode posterior to the second sustain pulse, according to the ratio of the specific sustain pulse number.

The sustain pulse driver may apply the first sustain pulse or the second sustain pulse to one of the scan electrode and the sustain electrode, and apply the same sustain pulse to the other of the scan electrode and the sustain electrode posterior to the supplied sustain pulse, according to the ratio of the specific sustain pulse number.

According to another embodiment of the present invention, a method of driving a plasma display apparatus in which a plurality of scan electrode and sustain electrode pairs are formed, comprising the step of supplying two or more sustain pulses having a different ER time to at least one of the scan electrode and the sustain electrode for a specific period as a ratio of a specific sustain pulse number.

The specific period may comprise at least one subfield period.

The ratio of the specific sustain pulse number may be different every subfield period.

The ER time may be at least one of an ER-up time and an ER-down time.

The sustain pulse may comprise a first sustain pulse having a first ER-up time, and a second sustain pulse having a second ER-up time longer than the first ER-up time.

The first ER-up time and the second ER-up time may be divided based on 500 ns.

All the second sustain pulses may be supplied in the first half of one subfield period, and the first sustain pulses are supplied posterior to the last second sustain pulse, according to the ratio of the specific sustain pulse number.

The second sustain pulse may be first supplied to one of the scan electrode and the sustain electrode, and the first sustain pulse may be then supplied to the other of the scan electrode and the sustain electrode posterior to the second sustain pulse, according to the ratio of the specific sustain pulse number.

The first sustain pulse or the second sustain pulse may be supplied to one of the scan electrode and the sustain electrode, and the same sustain pulse may be supplied to the other of the scan electrode and the sustain electrode posterior to the supplied sustain pulse, according to the ratio of the specific sustain pulse number.

### BRIEF DESCRIPTION OF THE DRAWINGS

The invention will be described in detail with reference to the following drawings in which like numerals refer to like elements.

FIG. 1 is a perspective view illustrating the construction of a general PDP;

FIG. 2 is a view illustrating a method of implementing images of a conventional plasma display apparatus;

FIG. 3 is a block diagram illustrating the construction of a plasma display apparatus according to an embodiment of the present invention;

FIG. 4 is a view illustrating the ER-up time of a sustain pulse according to an embodiment of the present invention;

FIG. 5 illustrates a first sustain pulse and a second sustain pulse according to an embodiment of the present invention;

FIG. 6 is a view illustrating driving margin characteristics of the plasma display apparatus according to an embodiment of the present invention;

FIG. 7 illustrates the supply order of the first sustain pulse and the second sustain pulse according to an embodiment of the present invention;

FIG. 8 illustrates the supply order of the first sustain pulse and the second sustain pulse according to another embodiment of the present invention; and

FIG. 9 illustrates the supply order of the first sustain pulse and the second sustain pulse according to still another embodiment of the present invention.

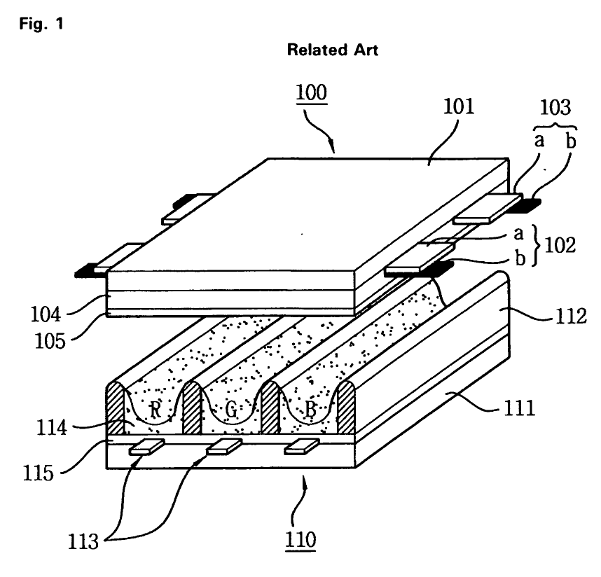

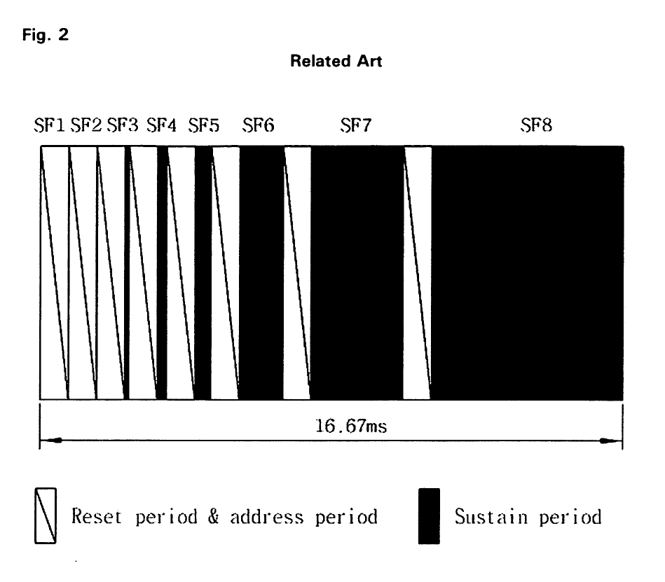

### DETAILED DESCRIPTION OF PREFERRED EMBODIMENTS

Specific embodiments of the present invention will be described in a more detailed manner with reference to the drawings.

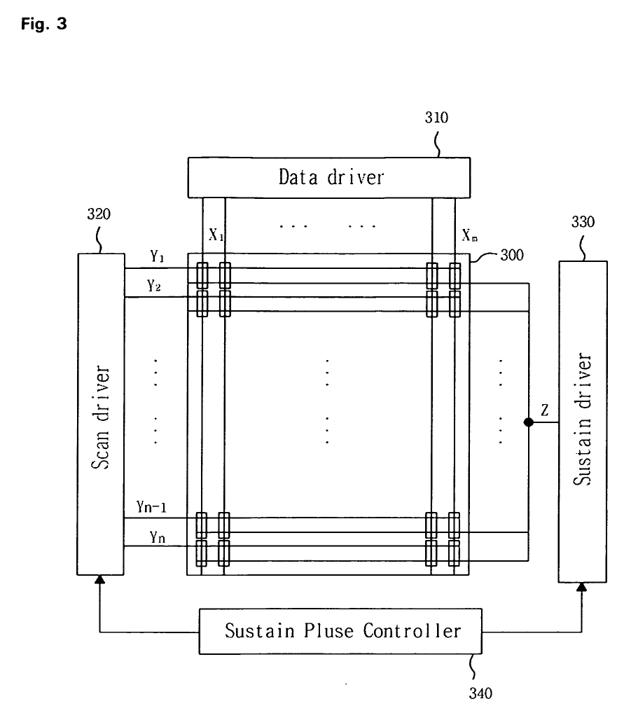

FIG. 3 is a block diagram illustrating the construction of a plasma display apparatus according to an embodiment of the present invention.

As illustrated in FIG. 3, the plasma display apparatus according to an embodiment of the present invention comprises a PDP 300, a data driver 310, a scan driver 320, a sustain driver 330 and a sustain pulse controller 340. In FIG. 3, it has been illustrated that the sustain pulse driver of the present invention is implemented using the scan driver 320 and the sustain driver 330 for supplying a sustain pulse to scan electrodes and sustain electrodes, respectively. However, the sustain pulse driver can be implemented using one driver.

The PDP 300 has a front substrate (not shown) and a rear substrate (not shown) coalesced together. A plurality of scan electrodes Y1 to Yn and a sustain electrode Z are formed in the front substrate. A plurality of address electrodes X1 to Xm crossing pairs of the scan electrodes Y1 to Yn and the sustain electrode Z are formed in the rear substrate.

The data driver 310 applies data to the address electrodes X1 to Xm formed in the PDP 300. The data refers to image signal data of externally input image signals, which have been processed by an image signal processor (not shown) so that the signals are suitable for the plasma display apparatus. The data driver 310 supplies an address pulse having an address voltage to each of the address electrodes X1 to Xm.

The scan driver 320 supplies a setup pulse, which forms a ramp-up waveform Ramp-up, to the scan electrodes Y1 to Yn during a setup period of a reset period, and also supplies a setdown pulse, which forms a ramp-down waveform Ramp-down, to the scan electrodes Y1 to Yn during a setdown period of the reset period. The scan driver 320 sequentially supplies a scan pulse of a scan voltage to the scan electrodes Y1 to Yn during an address period.

The scan driver 320 supplies two or more sustain pulses with a different ER time to the scan electrodes Y1 to Yn as the ratio of a specific sustain pulse number for a specific period during the sustain period under the control of the sustain pulse controller 340. The ER time may be an ER-up time or an ER-down time.

For example, the scan driver 320 can supply a first sustain pulse having a first ER-up time or a second sustain pulse having a second ER-up time longer than the first ER-up time. Alternatively, the scan driver 320 can supply a first′ sustain pulse having a first ER-down time or a second′ sustain pulse having a second ER-down time longer than the first ER-down time. Alternatively, the scan driver 320 can supply a second″ sustain pulse having a long ER-up time and a long ER-down time.

The sustain driver 330 supplies a bias voltage to the sustain electrode Z, which are commonly connected, during at least one of the setdown period and the address period, and supplies two or more sustain pulses having a different ER time as the ratio of a specific sustain pulse number for a specific period in the sustain period while operating alternately with the scan driver 320 under the control of the sustain pulse controller 340. The ER time can be at least one of the ER-up time and the ER-down time in the same manner as the scan driver 320.

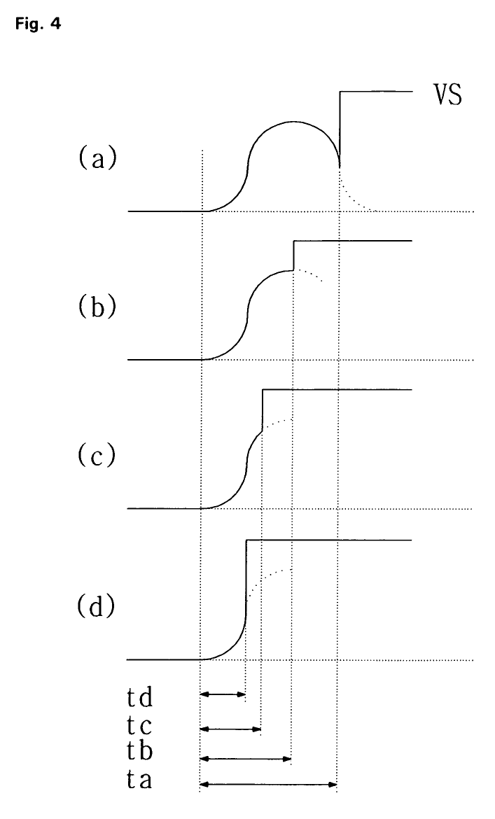

The sustain pulse controller 340 controls the operation of the scan driver 320 and the sustain driver 330. In particular, the sustain pulse controller 340 according to an embodiment of the present invention controls the ratio of the number of first sustain pulses, supplied for a specific period, to the number of second sustain pulses. The specific period corresponds to at least one subfield period. The ratio of a specific sustain pulse number may be varied depending on a subfield period. This is described in more detail below with reference to FIGS. 4 to 9.

FIG. 4 is a view illustrating the ER-up time of a sustain pulse according to an embodiment of the present invention.

As illustrated in FIG. 4, in an embodiment of the present invention, the ER-up time or the ER-down time of the sustain pulse is controlled. The ER-up time or the ER-down time is controlled using the energy recovery circuit for supplying energy to and recovering energy from the plasma display apparatus through L-C resonance. In other words, the ER-up time is controlled through an energy supply operation, and the ER-down time is controlled through an energy recovery operation. At the time of the energy supply operation, the ER-up time can be controlled depending on a point of time at which a sustain voltage Vs is applied, of time at which the voltage of the sustain pulse rises by means of L-C resonance. At the time of the energy recovery operation, the ER-down time can be controlled depending on a point of time at which the sustain voltage Vs is precluded prior to time at which the voltage of the sustain pulse falls by means of L-C resonance.

The correlation between the ER-up time of the sustain pulse and the peak luminance, and the correlation between the ER-up time of the sustain pulse and energy efficiency are described below with reference to FIG. 4.

“ta” to “td” denote ER-up times of sustain pulses “a” to “d”. “a” corresponds to a case where the sustain voltage Vs is supplied past a point of time at which the rising voltage is the highest, of time at which a rising voltage of the sustain pulse is supplied from the energy supply and recovery unit. “b” corresponds to a case where the sustain voltage Vs is supplied at a point of time at which the rising voltage is the highest through L-C resonance. “c” corresponds to a case where the sustain voltage Vs is forcibly supplied before the rising voltage becomes the highest. “d” corresponds to a case where the sustain voltage Vs is supplied faster than “c” before the rising voltage becomes the highest.

The correlation between the ER-up time and the peak luminance by sustain discharge is described below. In “a”, weak discharge is generated by the rising voltage since the sustain voltage Vs is supplied after the rising voltage becomes the highest. Accordingly, the peak luminance is the lowest. In “b”, the peak luminance is higher than that of “a” since a discharge is generated when the highest rising voltage is reached by L-C resonance. In “c” , a strong discharge is generated by the sustain voltage Vs abruptly supplied before the highest rising voltage is reached. Accordingly, the peak luminance of “a” is higher than that of “b”. Further, since the sustain voltage Vs is abruptly supplied in “d” than “c”, the peak luminance can be obtained.

The correlation between the ER-up time and energy efficiency by the sustain pulse is described below. “a” has the highest energy efficiency because the rising voltage sufficient L-C resonance is applied. The energy efficiency of “b” is lower than that of “a” since the ER-up time by L-C resonance is shorter than that of “a”. “c” has low energy efficiency since the sustain voltage Vs is applied before the highest rising voltage is reached. “d” has the lowest energy efficiency since the ER-up time by L-C resonance is the shortest. As described above, the peak luminance and energy efficiency can be varied depending on the ER-up time of the sustain pulse according to an embodiment of the present invention.

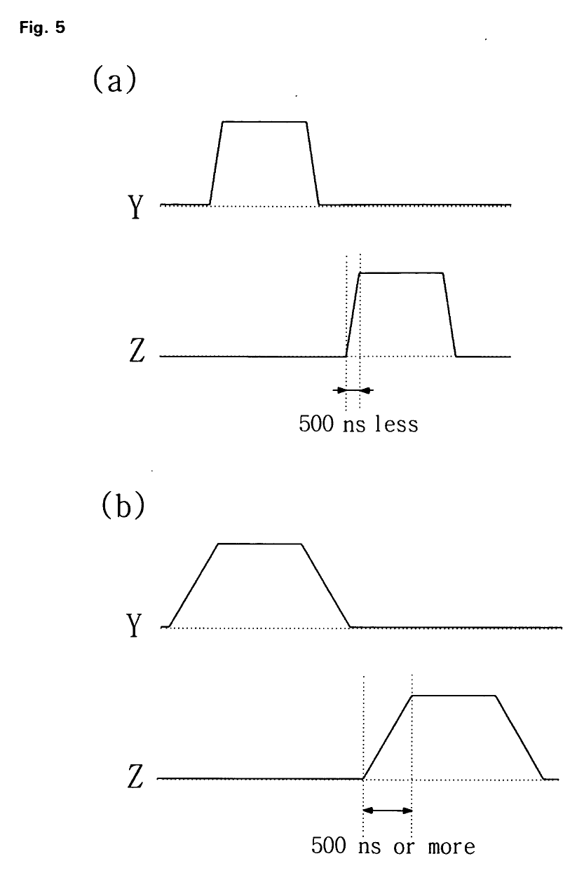

In the present embodiment, it is assumed that in the case of “c” and “d”, that is, a sustain pulse having a relatively short ER-up time is the first sustain pulse, and in the case of “a” and “b”, that is, a sustain pulse having a relatively long ER-up time is the second sustain pulse. The first sustain pulse and the second sustain pulse are described in detail below with reference to FIG. 5.

FIG. 5 illustrates the first sustain pulse and the second sustain pulse according to an embodiment of the present invention. FIG. 5(a) illustrates the first sustain pulse according to an embodiment of the present invention, and FIG. 5(b) illustrates the second sustain pulse according to an embodiment of the present invention.

As illustrated in FIG. 5(a), the first sustain pulse has a short ER-up time, and can therefore easily secure driving margin. Furthermore, since a peak luminance value is high, the sensitivity to a load phenomenon in which the luminance of the screen decreases as the load amount of the screen increases can be decreased. In addition, erroneous discharge depending on variation in the temperature of the PDP can be prohibited since a strong discharge is forcibly generated.

As illustrated in FIG. 5(b), the second sustain pulse has a long ER-up time, and can therefore improve driving efficiency by sufficiently utilizing the energy recovery circuit. As the sustain pulse is applied after a sufficient voltage rise, the load of a switching element of the driver can be alleviated. Accordingly, a temperature can be prevented from rising in the switching element and EelectroMagnetic Interference (EMI) can be decreased.

In addition, an after-image effect can be improved since the load to the PDP is decreased due to a weak discharge. The uniformity of the panel can be improved, and the occurrence of noise, which is incurred by a shaking phenomenon of the panel upon discharge, can be reduced. When a distance between transparent electrodes is narrow, for example, 100 μm or less, a firing voltage can be lowered and the luminance can be improved.

When the ER-up time of the sustain pulse is 500 ns or less, the characteristics of the first sustain pulse appear. When the ER-up time of the sustain pulse is 500 ns or more, the characteristics of the second sustain pulse appear. It is preferred that in the present embodiment, 500 ns, which is the ER-up time at which the characteristics of the first sustain pulse and the second sustain pulse are divided, is set to a reference ER-up time for dividing the first sustain pulse and the second sustain pulse.

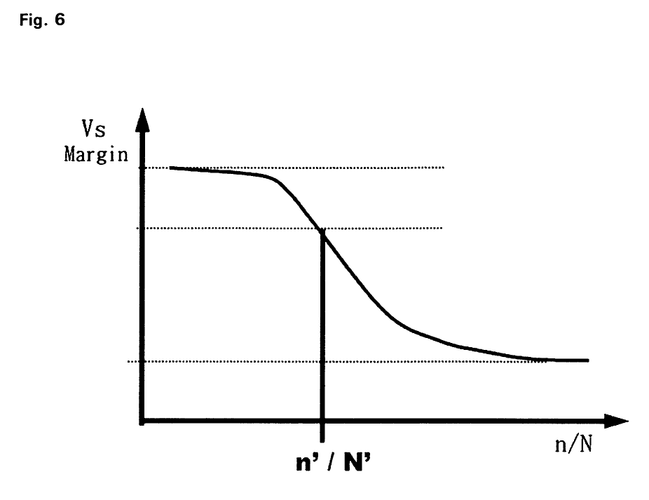

In order to utilize the advantages of the first sustain pulse and the second sustain pulse, in an embodiment of the present invention, the first sustain pulse and the second sustain pulse are mixed. In mixing the first sustain pulse and the second sustain pulse, the ratio of the first sustain pulse and the second sustain pulse is decided based on a driving margin curve as illustrated in FIG. 6.

FIG. 6 is a view illustrating driving margin characteristics of the plasma display apparatus according to an embodiment of the present invention.

Referring to FIG. 6, there is shown a graph illustrating driving margin (Vs margin) of the plasma display apparatus depending on the ratio n/N of the number of the second sustain pulses (n) to the number of the first sustain pulses (N). It can be seen from FIG. 6 that the driving margin (Vs margin) of the plasma display apparatus decreases as the number of the second sustain pulses (n) to the number of the first sustain pulses (N) increases. As described above, the driving margin plays an important role in mixing the first sustain pulse and the second sustain pulse.

The sustain pulse controller according to an embodiment of the present invention previously sets a threshold value by taking a smallest driving margin, depending on the reliability of the plasma display apparatus, into consideration. In other words, as illustrated in FIG. 6, a threshold value n′/N′ considering the smallest driving margin is previously set, and the number of the first sustain pulses (N) and the number of the second sustain pulses (n), of a total of sustain pulses allocated in a specific period (for example, one subfield period), is controlled such that the ratio n/N of the number of the second sustain pulses (n) to the number of the first sustain pulses (N) is smaller than the threshold value n′/N′.

Preferably, in order to utilize the advantages of the second sustain pulse to the greatest extent possible while securing the smallest driving margin, the ratio of the number of the second sustain pulses to the number of the first sustain pulses can be set lower than n′/N′.

The sustain pulse controller can decide the smallest number N′ of the first sustain pulses and the greatest number n′ of the second sustain pulses, which are supplied during one subfield period, according to the ratio n′/N′ of the number of the second sustain pulses to the number of the first sustain pulses, which is decided according to the threshold value.

In general, the threshold value is the ratio of the smallest number of sustain pulses having a short ER time and the greatest number of sustain pulses having a long ER time, of two sustain pulse with different ER times.

The sustain pulse driver, that is, the scan driver and the sustain driver supplied a decided number of the first sustain pulses and the second sustain pulses to the scan electrode or the sustain electrode.

Therefore, in an embodiment of the present invention, driving margin can be secured, and driving efficiency can also be improved. Furthermore, when input data, driving conditions or driving environment of the plasma display apparatus is changed, the number of the first and second sustain pulses is adaptively changed in a range by taking the smallest driving margin into consideration. It is therefore possible to take the advantages of the first sustain pulse and the advantages of the second sustain pulse uniformly.

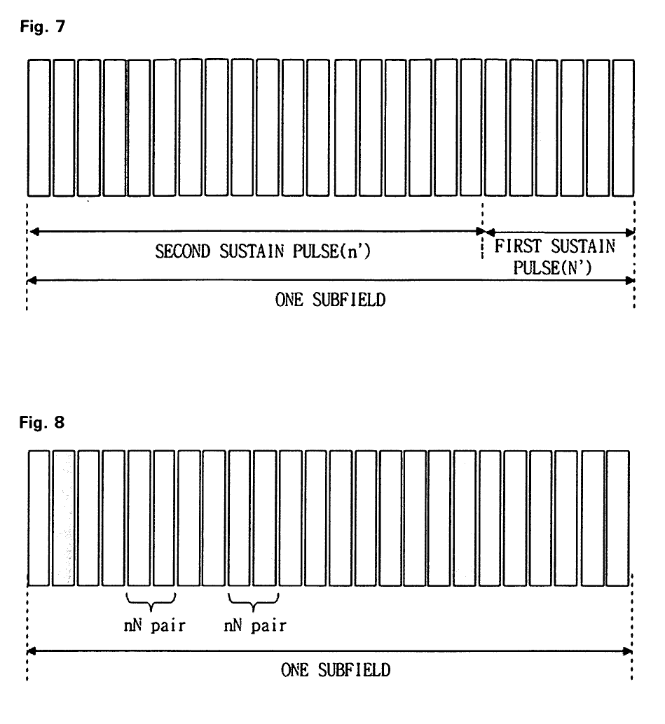

Meanwhile, the supply order of the first sustain pulse and the second sustain pulse, which have a number decided considering the smallest driving margin, according to an embodiment of the present invention can be changed in various ways as illustrated in FIGS. 7 to 9.

FIG. 7 illustrates the supply order of the first sustain pulse and the second sustain pulse according to an embodiment of the present invention.

As illustrated in FIG. 7, the sustain pulse driver according to an embodiment of the present invention supplies all the second sustain pulses in the first half of one subfield period, and supplies the first sustain pulses posterior to the last second sustain pulse in the second half of one subfield period, according to the ratio of the number of sustain pulses decided in the sustain pulse controller

Accordingly, driving margin and driving efficiency can be improved. Further, an after-image characteristic can be improved since the second sustain pulses are supplied in the first half of one subfield period, and a wall charge state of a PDP can be stabilized due to a strong discharge because the first sustain pulses are supplied in the second half of one subfield period.

FIG. 8 illustrates the supply order of the first sustain pulse and the second sustain pulse according to another embodiment of the present invention.

As illustrated in FIG. 8, the sustain pulse driver according to an embodiment of the present invention supplies the second sustain pulse to one of the scan electrode and the sustain electrode, and then supplies the first sustain pulse to the other of the scan electrode and the sustain electrode, according to the ratio of the number of sustain pulses decided in the sustain pulse controller.

As described above, in FIG. 7, after the second sustain pulse is supplied in the first half of one subfield, the first sustain pulse is supplied in the second half of one subfield. In FIG. 8, however, unlike FIG. 7, from the viewpoint of the sustain pulse pairs alternatively applied to the scan electrode and the sustain electrode, an after-image characteristic can be improved since the second sustain pulse is first supplied, and the wall charge state of the PDP can be stabilized due to a strong discharge since the first sustain pulse is supplied posterior to the second sustain pulse. In a similar way, in FIG. 8, driving efficiency can be improved while securing the smallest driving margin, by previously deciding the ratio of the number of the sustain pulses.

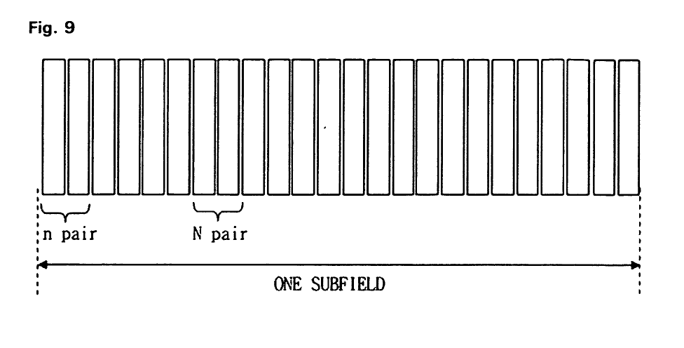

FIG. 9 illustrates the supply order of the first sustain pulse and the second sustain pulse according to still another embodiment of the present invention.

As illustrated in FIG. 9, the sustain pulse driver according to an embodiment of the present invention supplies the first sustain pulse or the second sustain pulse to one of the scan electrode and the sustain electrode, and also supplies the same sustain pulse to the other of the scan electrode and the sustain electrode posterior to the supplied sustain pulse, according to the ratio of the number of sustain pulses decided in the sustain pulse controller.

From the viewpoint of the sustain pulse pairs alternatively applied to the scan electrode and the sustain electrode, there are advantages in that driving timing can be controlled more easily because the sustain pulse pairs are raised according to the same ER-up time, and the scan electrode and the sustain electrode can be driven uniformly. In a similar way, in FIG. 9, driving efficiency can be improved while securing the smallest driving margin, by previously deciding the ratio of the number of the sustain pulses.

The method of driving the plasma display apparatus according to an embodiment of the present invention has been described in detail through the operating characteristic of each functional unit of the plasma display apparatus according to the present invention with reference to FIGS. 3 to 9, and will not be described further.

As described above, the present invention is advantageous in that it can secure driving margin when a plasma display apparatus is driven, by improving a plasma display apparatus and a method of driving the same.

Further, the present invention is advantageous in that it can improve driving efficiency when a plasma display apparatus is driven, by improving a plasma display apparatus and a method of driving the same.

In addition, the present invention is advantageous in that it can drive a plasma display apparatus more efficiently and stably.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus, comprising:
a Plasma Display Panel (PDP) in which a plurality of scan electrode and sustain electrode pairs are formed; and
a sustain pulse driver for supplying two or more sustain pulses having a different Energy Recovery (ER) time to at least one of the scan electrode and the sustain electrode for a specific period as a ratio of a specific sustain pulse number.

2. The plasma display apparatus as claimed in claim 1, wherein the specific period comprises at least one subfield period.

3. The plasma display apparatus as claimed in claim 2, wherein the ratio of the specific sustain pulse number is different every subfield period.

4. The plasma display apparatus as claimed in claim 1, wherein the ER time is at least one of an ER-up time and an ER-down time.

5. The plasma display apparatus as claimed in claim 1, wherein the sustain pulse comprises a first sustain pulse having a first ER-up time, and a second sustain pulse having a second ER-up time longer than the first ER-up time.

6. The plasma display apparatus as claimed in claim 5, wherein the first ER-up time and the second ER-up time are divided based on 500 ns.

7. The plasma display apparatus as claimed in claim 1, further comprising a sustain pulse controller for controlling the sustain pulse driver according to the ratio of the specific sustain pulse number.

8. The plasma display apparatus as claimed in claim 7, wherein the sustain pulse controller previously sets a specific threshold value corresponding to the smallest driving margin, and controls the number of sustain pulses so that the ratio of the specific sustain pulse number is smaller than the threshold value.

9. The plasma display apparatus as claimed in claim 8, wherein the threshold value is a ratio of the smallest number of sustain pulses having a short ER time and the greatest number of sustain pulses having a long ER time, of sustain pulses having a different ER time.

10. The plasma display apparatus as claimed in claim 5, wherein the sustain pulse driver applies all the second sustain pulses in the first half of one subfield period, and applies the first sustain pulses posterior to the last second sustain pulse, according to the ratio of the specific sustain pulse number.

11. The plasma display apparatus as claimed in claim 5, wherein the sustain pulse driver first applies the second sustain pulse to one of the scan electrode and the sustain electrode, and then applies the first sustain pulse to the other of the scan electrode and the sustain electrode posterior to the second sustain pulse, according to the ratio of the specific sustain pulse number.

12. The plasma display apparatus as claimed in claim 5, wherein the sustain pulse driver applies the first sustain pulse or the second sustain pulse to one of the scan electrode and the sustain electrode, and applies the same sustain pulse to the other of the scan electrode and the sustain electrode posterior to the supplied sustain pulse, according to the ratio of the specific sustain pulse number.

13. A method of driving a plasma display apparatus in which a plurality of scan electrode and sustain electrode pairs are formed, the method comprising the step of:
supplying two or more sustain pulses having a different ER time to at least one of the scan electrode and the sustain electrode for a specific period as a ratio of a specific sustain pulse number.

14. The method as claimed in claim 13, wherein the specific period comprises at least one subfield period.

15. The method as claimed in claim 14, wherein the ratio of the specific sustain pulse number is different every subfield period.

16. The method as claimed in claim 13, wherein the ER time is at least one of an ER-up time and an ER-down time.

17. The method as claimed in claim 13, wherein the sustain pulse comprises a first sustain pulse having a first ER-up time, and a second sustain pulse having a second ER-up time longer than the first ER-up time.

18. The method as claimed in claim 17, wherein the first ER-up time and the second ER-up time are divided based on 500 ns.

19. The method as claimed in claim 17, wherein all the second sustain pulses are supplied in the first half of one subfield period, and the first sustain pulses are supplied posterior to the last second sustain pulse, according to the ratio of the specific sustain pulse number.

20. The method as claimed in claim 17, wherein the second sustain pulse is first supplied to one of the scan electrode and the sustain electrode, and the first sustain pulse is then supplied to the other of the scan electrode and the sustain electrode posterior to the second sustain pulse, according to the ratio of the specific sustain pulse number.

21. The method as claimed in claim 17, wherein the first sustain pulse or the second sustain pulse is supplied to one of the scan electrode and the sustain electrode, and the same sustain pulse is supplied to the other of the scan electrode and the sustain electrode posterior to the supplied sustain pulse, according to the ratio of the specific sustain pulse number.

22. A method of driving a plasma display apparatus including a plurality of subfields each including a reset period, an address period, and a sustain period, wherein the plurality of subfields each have a different ratio of the number of sustain pulses which are defined by each ER time and are supplied to scan electrodes or/and sustain electrodes in the sustain period.
